(19) United States
(12) Patent Application Publication
(10) Pub. No.: US 2014/0346141 A1
(43) Pub. Date: Nov. 27, 2014

(54) SELF-ASSEMBLABLE POLYMER AND METHODS FOR USE IN LITHOGRAPHY

(71) Applicant: ASML Netherlands B.V., Veldhoven (NL)

(72) Inventors: Aurelie Marie Andree Brizard, Eindhoven (NL); Roelof Koole, Eindhoven (NL); Emiel Peeters, Eindhoven (NL)

(73) Assignee: ASML Netherlands B.V., Veldhoven (NL)

(21) Appl. No.: 14/369,958

(22) PCT Filed: Dec. 18, 2012
(86) PCT No.: PCT/EP2012/075989

§ 371 Date: Jun. 30, 2014

Related U.S. Application Data
(60) Provisional application No. 61/586,419, filed on Jan. 13, 2012.

(51) Int. Cl. B05D 3/10; B05D 1/00; B05D 1/28; B05D 3/00

(52) U.S. Cl. CPC B05D 3/107; B05D 3/007; B05D 1/60; B05D 1/28
USPC 216/49; 427/331; 427/255.6

(57) ABSTRACT

A method of forming a self-assembled block polymer layer, oriented to form an ordered array of alternating domains, is disclosed. The method involves providing a layer of the self-assemblable block copolymer on the substrate and depositing a first surfactant onto the external surface of the layer prior to inducing self-assembly of the layer to form the ordered array of domains. The first surfactant has a hydrophobic tail and a hydrophilic head group and acts to reduce the interfacial energy at the external surface of the block copolymer layer in order to promote formation of assembly of the block copolymer polymer into an ordered array having the alternating domains.

### CROSS-REFERENCE TO RELATED APPLICATIONS

This application claims the benefit of U.S. provisional application 61/586,419, which was filed on Jan. 13, 2012 and which is incorporated herein in its entirety by reference.

### FIELD

The present invention relates to a method of forming a self-assembled block copolymer layer, oriented to form an ordered array of alternating domains, arranged to lie side-by-side on a substrate. An embodiment of the invention further relates to device lithography method to pattern a surface of a substrate by resist etching, using the ordered array of self-assembled block polymer as a resist layer.

### BACKGROUND

In lithography for device manufacture, there is an ongoing desire to reduce the size of features in a lithographic pattern in order to increase the density of features on a given substrate area. Patterns of smaller features having critical dimensions (CD) at nano-scale allow for greater concentrations of device or circuit structures, yielding potential improvements in size reduction and manufacturing costs for electronic and other devices. In photolithography, the push for smaller features has resulted in the development of technologies such as immersion lithography and extreme ultraviolet (EUV) lithography.

So-called imprint lithography generally involves the use of a “stamp” (often referred to as an imprint template) to transfer a pattern onto a substrate. An advantage of imprint lithography is that the resolution of the features is not limited by, for example, the emission wavelength of a radiation source or the numerical aperture of a projection system. Instead, the resolution is mainly limited to the pattern density on the imprint template.

For both photolithography and for imprint lithography, it is desirable to provide high resolution patterning of surfaces, for example of an imprint template or of other substrates, and chemical resists may be used to achieve this.

The use of self-assembly of a block copolymer (BCP) has been considered as a potential method for improving the resolution to a better value than obtainable by prior art lithography methods or as an alternative to electron beam lithography for preparation of imprint templates.

A self-assemblable block copolymer is a compound useful in nanofabrication because it may undergo an order-disorder transition on cooling below a certain temperature (order-disorder transition temperature T_{OD}) resulting in phase separation of copolymer blocks of different chemical nature to form ordered, chemically distinct domains with dimensions of tens of nanometres or even less than 10 nm. The size and shape of the domains may be controlled by manipulating the molecular weight and composition of the different block types of the copolymer. The interfaces between the domains may have widths of the order of 1-5 nm and may be manipulated by modification of the chemical compositions of the blocks of the copolymers.

The feasibility of using thin films of block copolymers as self-assembling templates was demonstrated by Chaikin and Register, et al., Science 276, 1401 (1997). Dense arrays of dots and holes with dimensions of 20 nm were transferred from a thin film of poly(styrene-block-isoprene) to a silicon nitride substrate.

A block copolymer comprises different blocks, each comprising one or more identical monomers, and arranged side-by side along the polymer chain. Each block may contain many monomers of its respective type. So, for instance, an A-B block copolymer may have a plurality of type A monomers in the (or each) A block and a plurality of type B monomers in the (or each) B block. An example of a suitable block copolymer is, for instance, a polymer having covalently linked blocks of polystyrene (PS) monomer (hydrophobic block) and polymethylmethacrylate (PMMA) monomer (hydrophilic block). Other block copolymers with blocks of differing hydrophobicity/hydrophilicity may be useful. For instance a tri-block copolymer such as (A-B-C) or (A-B-A) block copolymer may be useful, as may an alternating or periodic block copolymer e.g. [-A-B-A-B-A-B-]ₙ or [-A-B-C-A-B-C]ₘ where n and m are integers. The blocks may be connected to each other by covalent links in a linear or branched fashion or for instance a star configuration.

A block copolymer may form many different phases upon self-assembly, dependent upon the volume fractions of the blocks, degree of polymerization within each block type (i.e. number of monomers of each respective type within each respective block), the optional use of a solvent and surface interactions. When applied in a thin film, the geometric confinement may pose additional boundary conditions that may limit the numbers of phases. In general spherical (e.g. cubic), cylindrical (e.g. tetragonal or hexagonal) and lamellar phases (i.e. self-assembled phases with cubic, hexagonal or lamellar space-filling symmetry) are practically observed in thin films of self-assembled block copolymers, and the phase type observed may depend upon the relative volume fractions of the different polymer blocks.

Suitable block copolymers for use as a self-assemblable polymer include, but are not limited to, poly(styrene-b-methylmethacrylate), poly(styrene-b-2-vinylpyridone), poly(styrene-b-butadiene), poly(styrene-b-ferrocenyldimethylsilane), poly(styrene-b-ethyleneoxide), poly(ethyleneoxide-b-isoprene). The symbol “b” signifies “block” Although these are di-block copolymer examples, it will be apparent that self-assembly may also employ a tri-block, tetrablock or other multi-block copolymer.

The self-assembled polymer phases may orient with symmetry axes parallel or perpendicular to the substrate and lamellar and cylindrical phases are interesting for lithography applications, as they may form 1-D or 2-D line and spacer patterns and hole arrays with alternating domains lying side-by-side on the substrate. In other words, the block copolymer molecules in the regular array may be oriented so that adjacent blocks of copolymer molecules are aligned side-by-side in the layer to form adjacent domains alternating with a periodicity along the plane of the surface of the substrate. Such ordered 1-D or 2-D arrays may provide good contrast when one of the domain types is subsequently etched.

Two methods used to guide or direct self-assembly of a polymer such as a block copolymer onto a surface are graphoepitaxy and chemical pre-patterning, also called chemical epitaxy. In the graphoepitaxy method, self-organization of a block copolymer is guided by topological pre-patterning of the substrate. A self-aligned block copolymer can form a parallel linear pattern with adjacent lines of the different polymer block domains in the trenches defined by the patterned substrate. For instance if the block copolymer is a di-block copolymer with A and B blocks within the polymer chain, where A is hydrophilic and B is hydrophobic in nature, the A blocks may assemble into domains formed adjacent to a side-wall of a trench if the side-wall is also hydrophilic in nature. Resolution may be improved over the resolution of the patterned substrate by the block copolymer pattern subdividing the spacing of a pre-pattern on the substrate.

In the chemical pre-patterning method (referred to herein as chemical epitaxy), the self-assembly of block copolymer domains is guided by a chemical pattern (i.e. a chemical template) on the substrate. Chemical affinity between the chemical pattern and at least one of the types of copolymer blocks within the polymer chain may result in the precise placement (also referred to herein as “pinning”) of one of the domain types onto a corresponding region of the chemical pattern on the substrate. For instance if the block copolymer is a di-block copolymer with A and B blocks, where A is hydrophilic and B is hydrophobic in nature, and the chemical pattern comprises a hydrophobic region on a hydrophilic, or neutral, surface, the B domain may preferentially assemble onto the hydrophobic region. As with the graphoepitaxy method of alignment, the resolution may be improved over the resolution of the patterned substrate by the block copolymer pattern subdividing the spacing of pre-patterned features on the substrate (so-called density multiplication). Chemical pre-patterning is not limited to a linear pre-pattern; for instance the pre-pattern may be in the form of a 2-D array of dots suitable as a pattern for use with a cylindrical phase-forming block copolymer. Graphoepitaxy and chemical pre-patterning may be used, for instance, to guide the self-organization of lamellar or cylindrical phases, where the different domain types are arranged side-by-side on a surface of a substrate.

### SUMMARY

In a process to implement the use of block copolymer self-assembly in nanofabrication, a substrate may be modified with a neutral orientation control layer, as part of the chemical pre-pattern or graphoepitaxy template, to induce the preferred orientation of the self-assembly pattern in relation to the substrate. For some block copolymers used in self-assemblable polymer layers, there may be a preferential interaction between one of the blocks and the substrate surface that may result in orientation. For instance, for a polystyrene(PS)-b-PMMA block copolymer, the PMMA block will preferentially wet (i.e. have a high chemical affinity with) an oxide surface and this may be used to induce the self-assembled pattern to lie oriented parallel to the plane of the surface. Perpendicular orientation may be induced, for instance, by depositing a neutral orientation layer onto the surface rendering the substrate surface neutral to both blocks, in other words the neutral orientation layer has a similar chemical affinity for each block, such that both blocks wet the neutral orientation layer at the surface in a similar manner. By “perpendicular orientation” it is meant that the domains of each block will be positioned side-by-side at the substrate surface, with the interfacial regions between domains of different blocks lying substantially perpendicular to the plane of the surface. In other words, the block copolymer molecules in the regular array are oriented so that adjacent domains of blocks of copolymer molecules are aligned side-by-side in the layer to form adjacent domains alternating with a periodicity along the plane of the layer, with both domain types in contact with, and wetting, the substrate. By the term “parallel orientation” is meant that stacks of alternating domains are formed having a periodicity along an axis normal to the plane of the layer, typically with one domain type wetting the substrate.

A neutral surface for use in chemical epitaxy and graphoepitaxy is particularly useful when perpendicular orientation of ordered arrays is desired. It may be used on surfaces between specific orientation regions of an epitaxy template. For instance in a chemical epitaxy template to align a di-block copolymer with A and B blocks, where A is hydrophilic and B is hydrophobic in nature, the chemical pattern may comprise hydrophobic pinning regions with a neutral orientation region between the hydrophobic regions. The B domain may preferentially assemble onto the hydrophobic pinning regions, with several alternating domains of A and B blocks aligned over the neutral region between the specific (pinning) orientation regions of the chemical pre-pattern.

For instance in a graphoepitaxy template to align such a di-block copolymer the pattern may comprise hydrophobic resist features with a neutral orientation region between the hydrophobic resist features. The B domain may preferentially assemble alongside the hydrophobic resist features, with several alternating domains of A and B blocks aligned over the neutral orientation region between the specific (pinning) orientation resist features of the graphoepitaxy template.

A neutral orientation layer may, for instance, be created by use of random copolymer brushes which are covalently linked to the substrate by reaction of a hydroxyl terminal group, or some other reactive end group, to oxide at the substrate surface. In other arrangements for neutral orientation layer formation, a crosslinkable random copolymer or an appropriate silane (i.e. molecules with a substituted reactive silane, such as a (tri)chlorosilane or (tri)methoxysilane, also known as silyl, end group) may be used to render a surface neutral by acting as an intermediate layer between the substrate surface and the layer of self-assemblable polymer. Such a silane based neutral orientation layer will typically be present as a monolayer whereas a crosslinkable polymer is typically not present as a monolayer and may have a layer thickness of typically less than or equal to 40 nm. The neutral orientation layer may, for instance, be provided with one or more gaps therein to permit one of the block types of the self-assemblable layer to come into direct contact with the substrate below the neutral orientation layer. This may be useful for anchoring, pinning or aligning a domain of a particular block type of the self-assemblable polymer layer to the substrate, with the substrate surface acting as a specific orientation feature.

A thin layer of self-assemblable polymer may be deposited onto the substrate, onto a graphoepitaxy or chemical epitaxy template as set out above. A suitable method for deposition of the self-assemblable polymer is spin-coating, as this process is capable of providing a well defined, uniform, thin layer of self-assemblable polymer. A suitable layer thickness for a deposited self-assemblable polymer film is approximately 10 to 100 nm. Following deposition of the block copolymer film, the film may still be disordered or only partially ordered and one or more additional steps may be needed to promote and/or complete self-assembly. For instance, the self-assemblable polymer may be deposited as a solution in a solvent, with solvent removal, for instance by evaporation, prior to self-assembly.

Self-assembly of a block copolymer is a process where the assembly of many small components (the block copolymer) results in the formation of a larger more complex structure (the nanometer sized features in the self-assembled pattern, referred to as domains in this specification). Defects arise naturally from the physics controlling the self-assembly of the polymer. Self-assembly is driven by the differences in interactions (i.e. differences in mutual chemical affinity) between A/A, B/B and A/B (or B/A) block pairs of an A-B block copolymer, with the driving force for phase separation described by Flory-Huggins theory for the system under consideration. The use of chemical epitaxy or graphoepitaxy may greatly reduce defect formation.

For a polymer which undergoes self-assembly, the self-assemblable polymer will exhibit an order-disorder temperature T_{OD}. T_{OD} may be measured by any suitable technique for assessing the ordered/disordered state of the polymer, such as differential scanning calorimetry (DSC). If layer formation takes place below this temperature, the molecules will be driven to self-assemble. Above the temperature T_{OD}, a disordered layer will be formed with the entropy contribution from disordered A/B domains outweighing the enthalpy contribution arising from favorable interactions between neighboring A-A and B-B block pairs in the layer. The self-assemblable polymer may also exhibit a glass transition temperature T_{g} below which the polymer is effectively immobilized and above which the copolymer molecules may still reorient within a layer relative to neighboring copolymer molecules. The glass transition temperature is suitably measured by differential scanning calorimetry (DSC).

If T_{OD} is less than T_{g} for the block copolymer, then a self-assembled layer will be unlikely to form or will be highly defected because of the inability of the molecules to align correctly when below T_{OD} and below T_{g}. A preferred block copolymer for self assembly has T_{OD} higher then T_{g}. However, once the molecules have assembled into a solid-like layer, even when annealed at a temperature above T_{g} but below T_{OD}, the mobility of the polymer molecules may be insufficient to provide adequate intermingling of coiled polymer chains to allow the molecules to relax into their states of lowest total free energy. This may result in domain placement error for the self-assembled polymer, where the phase separated domains of differing polymer blocks may not be precisely located on the ideal theoretical lattice positions that they would occupy if the lowest total free energy state were to be reached.

Defects formed during ordering as set out above may be partly removed by annealing. A defect such as a disclination (which is a line defect in which rotational symmetry is violated, e.g. where there is a defect in the orientation of a director) may be annihilated by pairing with other another defect or disclination of opposite sign. Chain mobility of the self-assemblable polymer may be a factor for determining defect migration and annihilation and so annealing may be carried out at a temperature where chain mobility is high but the self-assembled ordered pattern is not lost. This implies temperatures up to a few tens of ° C. above or below the order/disorder temperature T_{OD} for the polymer, say up to about 50° C.

Ordering and defect annihilation may be combined into a single annealing process or a plurality of processes may be used in order to provide a layer of self-assembled polymer such as block copolymer, having an ordered pattern of domains of differing chemical type (of domains of different block types), for use as a resist layer for lithography.

In order to transfer a pattern, such as a device architecture or topology, from the self-assembled polymer layer into the substrate upon which the self-assembled polymer is deposited, typically a first domain type will be removed by so-called breakthrough etching to provide a pattern of a second domain type on the surface of the substrate with the substrate laid bare between the pattern features of the second domain type.

Following the breakthrough etching, the pattern may be transferred by so-called transfer etching using an etching means which is resisted by the second domain type and so forms recesses in the substrate surface where the surface has been laid bare. Other methods of transferring a pattern, known in the art, may be applicable to a pattern formed by self-assembly of a block copolymer.

The precise control of the orientation of block copolymer in a thin layer is significant for exploitation of the potential of such material for a device lithography application. In most cases, “perpendicular orientation” of lamellae or cylinders, for instance, is desired so that a block copolymer resist layer, in the form of 1-D or 2-D ordered array, is formed. The self-assembled domains in such a layer is oriented to provide a suitable mask for use in patterning of the underlying substrate.

In a thin film or layer of block copolymer, interfacial interactions dictate the wetting property at the substrate interface (i.e. at the interface between the substrate and the block copolymer layer) and at the external interface of the block copolymer layer (i.e. at the outer surface of the block copolymer layer where there will be an interface with an ambient surrounding, for instance the atmosphere).

If a block of the block copolymer has a high chemical affinity for the substrate, this may lead to preferential wetting of the substrate by that block at the substrate interface, and consequently this may result in parallel orientation of domains being favored over the desired perpendicular orientation.

In a similar manner, if one of the blocks of the block copolymer is driven by chemical affinity to lie at the external interface of the block copolymer layer, this may drive the layer to self-assemble with a parallel orientation rather than with a desired perpendicular orientation.

As set out hereinbefore, the substrate interface may be modified with a neutral brush polymer, silane, crosslinked layer or the like in order to favor perpendicular orientation at the substrate interface, by providing a substrate interface which has a high chemical affinity for, e.g., hydrophilic and hydrophobic blocks of the block copolymer.

However, it is desirable to provide an external interface that has a high chemical affinity for, e.g., both hydrophilic and hydrophobic blocks of the block copolymer, in order to avoid, or reduce, the risk of one particular domain type being preferentially driven to lie at the external interface. This could potentially lead to induction of a parallel orientation, at least in the region of the external interface, for the resulting self-assembled block copolymer. For example, where the external interface is with air or a vacuum, the hydrophobic blocks of the block copolymer typically will have a greater chemical affinity for air or vacuum, leading to their being driven to occupy the external interface and reducing the relative proportion of hydrophilic blocks at the external interface.

Also, although the techniques, set out hereinbefore, to apply a block copolymer self-assembled layer to a surface may provide partial alignment of the block copolymer structure on a substrate, the resulting self-assembled layer may exhibit a high level of incorrectly aligned polymer molecules, leading to defects and/or poor uniformity in domain placement, which in turn may result in undesirable variation in critical dimension.

In a self-assembled structure, defects are likely to be present. In most cases, the thermodynamic driving force for self-assembly is provided by weak intermolecular interactions and is typically of the same order of magnitude as the entropy term. This characteristic is probably one of the main limitations in the exploitation of self-assembled features for lithography. Current state-of-the-art self-assembled layers may exhibit a defect rate of 1 in 10³ to 1 in 10⁴, expressed as the number of non-functional features of a multi-component device derived from the self-assembled layer (see for example Yang et. al, ACS Nano, 2009, 3, 1844-1858). This is several orders of magnitude higher than a defect level that would be desired for commercial effectiveness. These defects may appear as grain boundaries (discontinuities in the pattern) or as dislocations.

Undesired parallel orientation of domains at the external interface, or at least a driving force encouraging such parallel orientation, rather than the desired perpendicular orientation, may also promote defect formation within a self-assembled array intended to have perpendicular orientation relative to a substrate, for use as a device lithography resist. Son et al. (Son, J. G. Bulliard, X. Kang, H. Nealey, P. F.; Char, K. Advanced Materials. 2008, 20, 3643-3648) discuss mixing oleic acid, as a surfactant, with PS-b-PMMA prior to spin coating of a block copolymer layer. The presence of the surfactant mixed in with the block copolymer, as disclosed in Son et. al., is likely to lead to increased miscibility of the blocks of the block copolymer, leading to reduction in the Flory-Huggins parameter and a consequent increase in placement defects and reduction in critical dimension uniformity.

It is desirable, for example, to provide a method which tackles one or more of the problems in the art, particularly a problem deriving from undesired parallel orientation of block copolymer self assembly at an external interface of a layer when self-assembled block copolymer with perpendicular orientation is desired for use, e.g., as a resist layer for device lithography.

It is desired, for example, to provide a method useful for forming a self-assembled layer of block copolymer, in particular suitable for use as a resist layer in device lithography, which provides a self-assembled ordered array having a perpendicular orientation and low defect levels (providing good critical dimension uniformity, low line edge roughness and accurate domain placement).

By “chemical affinity”, in this specification, is meant the tendency of two differing chemical species to associate together. For instance chemical species which are hydrophilic in nature have a high chemical affinity for water whereas hydrophobic compounds have a low chemical affinity for water but a high chemical affinity for an alkane. Chemical species which are polar in nature have a high chemical affinity for other polar compounds and for water whereas apolar, non-polar or hydrophobic compounds have a low chemical affinity for water and polar species but may exhibit high chemical affinity for other non-polar species such as an alkane or the like. The chemical affinity is related to the free energy associated with an interface between two chemical species: if the interfacial free energy is high, then the two species have a low chemical affinity for each other whereas if the interfacial free energy is low, then the two species have a high chemical affinity for each other. Chemical affinity may also be expressed in terms of “wetting”, where a liquid will wet a solid surface if the liquid and surface have a high chemical affinity for each other, whereas the liquid will not wet the surface if there is a low chemical affinity. It should be noted, however, that, for example, two hydrophobic species may not necessarily have a high chemical affinity with each other, even though they are both hydrophobic. For instance, an alkyl chain and a perfluorinated alkyl chain are both hydrophobic, but may also be mutually immiscible.

By “chemical species” in this specification is meant either a chemical compound such as a molecule, oligomer or polymer, or, in the case of an amphiphilic molecule (i.e. a molecule having at least two interconnected moieties having differing chemical affinities), the term “chemical species” may refer to the different moieties of such molecules. For instance, in the case of a di-block copolymer, the two different polymer blocks making up the block copolymer molecule are considered as two different chemical species having differing chemical affinities.

Throughout this specification, the term “comprising” or “comprises” means including the component(s) specified but not to the exclusion of the presence of others. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, a composition consisting essentially of a set of components will comprise less than 5% by weight, typically less than 3% by weight, more typically less than 1% by weight of non-specified components.

Whenever appropriate, the use of the term “comprises” or “comprising” may also be taken to include the meaning “consists essentially of” or “consisting essentially of”, or may include the meaning “consists of” or “consisting of”.

Wherever mention is made of a “layer” in this specification, the layer referred to is to be taken to be layer of substantially uniform thickness, where present. By “substantially uniform thickness” is meant that the thickness varies by less than 20% about the mean thickness.

By “immiscible”, as used herein, it is meant that a compound said to be immiscible with another compound has a solubility in that compound of less than 1% by weight at equilibrium, and vice versa, at a temperature of 50° C., or less, in excess of the melting point of the highest melting compound.

According to an aspect, there is provided a method of forming an ordered array of self-assemblable block copolymer on a substrate, the method comprising:
providing a substrate having a layer of self-assemblable block copolymer thereon, the block copolymer having a molecule comprising a hydrophilic block and a hydrophobic block, and the layer having an external surface,
depositing a first surfactant onto the external surface of the layer, the first surfactant having a molecule with a hydrophobic tail and a hydrophilic head group, the hydrophilic head group adapted to adsorb the first surfactant to the hydrophilic block of the block copolymer, and
treating the layer to cause self-assembly of the self-assemblable block copolymer to form the ordered array of self-assemblable block copolymer from the layer on the substrate.

According to an aspect, there is provided a lithography method to pattern a surface of a substrate by resist etching, wherein the method comprises providing an ordered array of self-assemblable block copolymer on the substrate at the surface a method described herein, wherein the ordered array of self-assemblable block copolymer is used as a resist layer.

According to an aspect, there is provided a method to form a device topography at a surface of a substrate, the method comprising using an ordered array of self-assemblable block copolymer formed on the substrate by a method described herein as a resist layer while etching the substrate to provide the device topography.

The following features are applicable to all the various aspects of the methods described herein where appropriate. When suitable, combinations of the following features may be employed as part of the methods, for instance as set out in the claims. The methods may be particularly suitable for use in device lithography. For instance the methods may be used for treatment or formation of a resist layer of self-assembled polymer for use in patterning a device substrate directly or for use in patterning an imprint template for use in imprint lithography.

In this specification, PMMA is used to denote polymethylmethacrylate, PS to denote polystyrene and PEO to denote polyethylene oxide.

In an embodiment, there is provided a method of forming an ordered layer of a self-assemblable block copolymer. This may be a block copolymer as set out hereinbefore comprising at least two different block types which are self-assemblable into an ordered polymer layer having the different block types associated into first and second domain types. The block copolymer may be a di-block copolymer or a tri-block or multi-block copolymer. Alternating or periodic block copolymer may be used as the self-assemblable polymer. Although only two domain types may be mentioned in some of the following aspects and examples, an embodiment of the invention may be applicable to a self-assemblable block copolymer with three or more different domain types.

The block copolymer has a molecule which comprises at least a first hydrophilic block of first monomer and a second hydrophobic block of second monomer. One of the first or second blocks is more hydrophilic than the other block, whereby the first and second blocks may be referred to as hydrophilic and hydrophobic blocks respectively. The block copolymer, as explained hereinbefore, is thus adapted to undergo a transition from a disordered state to an ordered state at a temperature less than T_{OD}. For the sake of clarity, the ordered state may also be achieved, for instance, by having the block copolymer in the presence of a solvent, with the ordering achieved by removal of the solvent, for instance by evaporation. For some block copolymers, the value of T_{OD} may be greater than the decomposition temperature T_{dec} for the polymer, and so ordering by loss of solvent may be preferred. Similarly, annealing may be carried out in the presence of solvent, for instance added to the block copolymer using solvent vapor, in order to provide for increased mobility of the block copolymer to allow re-ordering without necessarily taking the block copolymer above T_{OD}. The ordering may be achieved for a solvent-free block copolymer by cooling it through the temperature T_{OD} and annealing achieved by cycling the temperature above and below T_{OD}.

In this specification, T_{OD} and T_{g} refer to the block copolymer as such. However, it will be understood that an embodiment of the invention may also be put into effect with a block copolymer in the presence of a solvent which may affect the block copolymer chain mobility.

Typically, the layer of self-assemblable block copolymer may be provided on the substrate by deposition, using a suitable deposition method such as spin-coating. The block copolymer may be held at a temperature above T_{OD} and/or may be dissolved in a solvent to help ensure that it is in a disordered state prior, prior to removal of solvent and/or cooling to a temperature below T_{g}. The surfactant may be deposited onto the external face with the block copolymer in a disordered state. The surfactant may be deposited onto the external face with the block copolymer at a temperature below T_{g}.

The molecular weight of the first surfactant is typically 20% or less than the molecular weight of the block copolymer, for instance 10% or less. The molecular weight of the first surfactant may be 5% or less than that of the block copolymer. Molecular weight, as used herein, means number average molecular weight Mn, for instance as measured by size exclusion chromatography.

The layer of block copolymer is provided on the substrate, and may typically be deposited onto the substrate by means of a suitable method such as spin-coating, with the block copolymer in a molten state, or dissolved in a suitable solvent which may be subsequently removed, for instance by evaporation or other suitable method, to leave a layer consisting essentially of the block copolymer. The layer of block copolymer will have an external surface and an interface with the substrate, the external surface and the substrate interface forming opposed surfaces of the layer. Although some partial ordering (i.e. self-assembly) of the block copolymer may occur during deposition of the block copolymer layer onto the substrate, the block copolymer will generally be in a substantially disordered state immediately following its deposition onto the substrate.

The substrate may be of a material of use for device lithography, such as a semiconductor, and the block copolymer may be deposited directly onto the material, or onto some intermediate layer already deposited onto the material surface, such as an anti-reflection coating (ARC) layer on the material surface, or a graphoepitaxy or chemical epitaxy template. As already explained hereinbefore, the substrate surface onto which the block copolymer is provided may be already modified, at least in part, to have a chemical affinity for both the hydrophilic and hydrophobic blocks of the block copolymer whereby so-called perpendicular orientation (as defined herein) is encouraged.

The method includes depositing a first surfactant onto the external surface of the layer, wherein the first surfactant has a molecule comprising, consisting essentially, or consisting of a hydrophobic tail and a hydrophilic head group, the hydrophilic head group adapted to adsorb the first surfactant to the hydrophilic block of the block copolymer.

The method may further include treating the layer of self-assemblable block copolymer, for instance by annealing, to cause self-assembly to form an ordered array of self-assemblable block copolymer from the layer on the substrate.

The term “surfactant” as used in this specification means a molecule having a hydrophilic head group and a hydrophobic tail group, such as a nonionic, anionic, cationic, amphoteric or zwitterionic surfactant.

The hydrophilic head group may be a suitable oligomeric moiety of the same monomer or monomers as a monomer or monomers of the hydrophilic block of the block copolymer. For instance, if the hydrophilic block of the block copolymer is a homopolymer of ethylene oxide monomer, the head group of the first surfactant may be an oligomer of ethylene oxide monomer.

Although the hydrophilic tail may be miscible with the hydrophobic block of the block copolymer, the hydrophobic tail group of the first surfactant is desirably adapted to be immiscible with the hydrophobic block of the block copolymer.

For instance, the hydrophobic tail group of the first surfactant may comprise a perfluorinated moiety, or may consist essentially or consist of a perfluorinated moiety. In another suitable arrangement, the hydrophobic tail group of the first surfactant may comprise, consist essentially of or consist of a polydimethylsiloxane moiety.

The hydrophobic tail group and the hydrophilic head group of the first surfactant may linked by a cleavable linking group, the method further comprising cleaving the cleavable linking group after treating the layer of self-assemblable block copolymer to cause self-assembly and removing the hydrophilic tail group following cleavage. A suitable cleavable linking group includes a cyclic and/or acyclic acetal, ketal, ortho-ester (e.g. suitable for acid cleavage), ester bond (e.g. suitable for alkali cleavage), azo bond, and/or nitrophenyl group (UV cleavable).

The first surfactant may suitably be deposited onto the external surface by adsorption from a liquid composition comprising a solvent and the first surfactant. For instance, straightforward deposition from solution may be used by dipping the substrate into a liquid composition which is a dilute solution of the first surfactant. An aqueous solution of first surfactant may be used where the block copolymer is insoluble in water (i.e. having a solubility in water at 25° C. of 0.1% by weight or less). In another suitable arrangement, the first surfactant may be deposited onto the external surface by Langmuir-Blodgett deposition from the liquid composition. In this latter case, the liquid composition may be arranged as a composition having a monolayer of first surfactant at the interface with the ambient environment (e.g., air) such that dipping of the substrate leads to deposition of a monolayer of first surfactant at the external surface. In an arrangement where the first surfactant is soluble in liquid which is not a solvent for the block copolymer (such as an alcohol or fluorinated solvent, for instance), the first surfactant may be deposited from very dilute solution of the solvent, to yield a thin first surfactant layer on the external surface of the block copolymer layer.

The first surfactant may be deposited onto the external surface by deposition from a vapor phase. This method is suitable in the event that the first surfactant is sufficiently volatile at a deposition temperature so that decomposition of the components is not an issue.

In another suitable arrangement, the first surfactant may be deposited onto the external surface by contact printing. In this specification, the term contact printing also includes molecular transfer printing and etch transfer printing.

Another suitable method for providing the layer of self-assemblable block copolymer on the substrate may be by:
depositing a film of liquid composition comprising the first surfactant, the block copolymer and a solvent onto the substrate, and
removing the solvent by evaporation to form the layer of self-assemblable block copolymer,
wherein the first surfactant is immiscible with the block copolymer and migrates to, and is deposited, on the external surface as the solvent is removed.

For this method of deposition of first surfactant, it is desirable that the first surfactant is sufficiently immiscible with the block copolymer such that the first surfactant is not present at substantial levels (say 1% by weight or less) within the ordered array.

The hydrophobic tails of the first surfactant molecules may be adapted for mutual crosslinking, wherein following deposition of the first surfactant onto the external surface, the hydrophilic tails are mutually crosslinked. Such crosslinking may be achieved by use, for instance, of an epoxy or acrylate group in the tail of the first surfactant, with crosslinking achievable, for instance, by irradiation with actinic radiation of the first surfactant (e.g. UV irradiation).

The deposition of the first surfactant onto the external surface may include depositing a second surfactant onto the external surface, the second surfactant having a second head group adapted to adsorb the second surfactant to a hydrophobic block of the block copolymer and a second tail group adapted to be immiscible with both the hydrophilic and hydrophobic blocks of the block copolymer.

In particular, the tail group of the first surfactant and the tail group of the second surfactant may be chemically identical.

The second surfactant may be deposited on the external surface of the layer contemporaneously with the first surfactant, or may be deposited in a second process included within the deposition of the first surfactant onto the external surface. One or more of the methods for deposition of the first surfactant as set out herein may be employed for contemporaneous or separate deposition of the second surfactant. Contemporaneous deposition is preferred as a simpler process.

An aspect of the invention provides a lithography method for patterning a surface of a substrate by resist etching, wherein the method comprises providing an array of self-assemblable block copolymer on a substrate at the surface by a method as set out herein, wherein the self-assembled block copolymer layer in the form of an ordered array is used as a resist layer.

For instance, the different domains (perpendicular oriented domains of hydrophilic block and hydrophobic block respectively) of the ordered array of block copolymer may each exhibit different etch resistivity. Alternatively, one of the domains of a particular block may be selectively removed, e.g. by photo-degradation, and the remaining domains of the other block may serve as an etch resist.

An aspect of the invention provides a method for forming a device topography at a surface of a substrate, the method comprising using the ordered array of self-assemblable block copolymer formed on the substrate by a method as set out herein as a resist layer while etching the substrate to provide the device topography.

The methods are useful when used with a substrate having a graphoepitaxy or chemical epitaxy template provided thereon, as set out hereinbefore.

### BRIEF DESCRIPTION OF THE DRAWINGS

Specific embodiments of the invention will be described with reference to the accompanying Figures, in which:

FIGS. 1A to 1C schematically depict directed self-assembly of A-B block copolymers onto a substrate by graphoepitaxy and formation of a relief pattern by selective etching of one domain;

FIGS. 2A to 2C schematically depict directed self-assembly of A-B block copolymers onto a substrate by chemical pre-patterning and formation of a relief pattern by selective etching of one domain;

FIGS. 3A to 3E schematically depict the different phases formed by a poly(styrene-b-methylmethacrylate) polymer as the relative volume fractions of the polystyrene and PMMA blocks are varied relative to each other; and

FIGS. 4A to 4D depict molecular structures of embodiments of first surfactants suitable for an embodiment of the invention.

### DETAILED DESCRIPTION

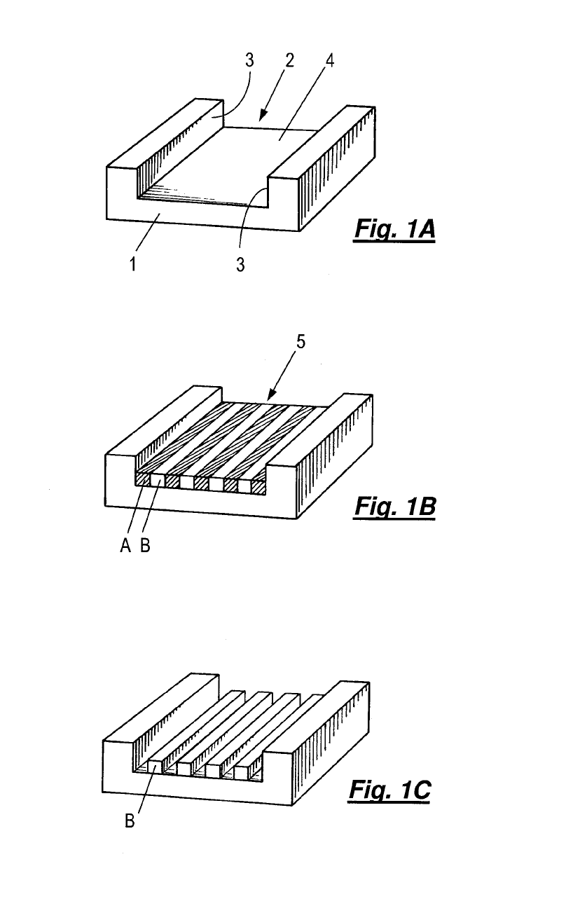

FIG. 1A shows a substrate 1 with a trench 2 formed therein bounded by side walls 3 and a bottom surface 4. In FIG. 1B, a self-assemblable A-B block copolymer with, e.g., hydrophilic A blocks and, e.g., hydrophobic B blocks has been deposited into the trench to form a layer 5 with alternating stripes of A and B domains which have deposited as a lamellar phase separated into discrete micro-separated periodic domains during deposition of the block copolymer. This is referred to as graphoepitaxy. The type A domains have nucleated adjacent to the a side wall 3, which is also, e.g., hydrophilic. In FIG. 1C, the type A domains have been removed by selective chemical etching, leaving the type B domains to form a relief pattern in the trench where they may serve as a template for subsequent patterning of the bottom surface 4, for instance by further chemical etching. Selective removal may be achieved, for instance, by selective photo-degradation or photo-cleavage of a linking agent between blocks of the copolymer and subsequent solubilization of one of the blocks. The pitch or wavelength of the self-assembled polymer structure 5 and the width of the trench 4 are arranged so that a number of alternating stripes of domains can fit into the trench with a type A domain against each side wall.

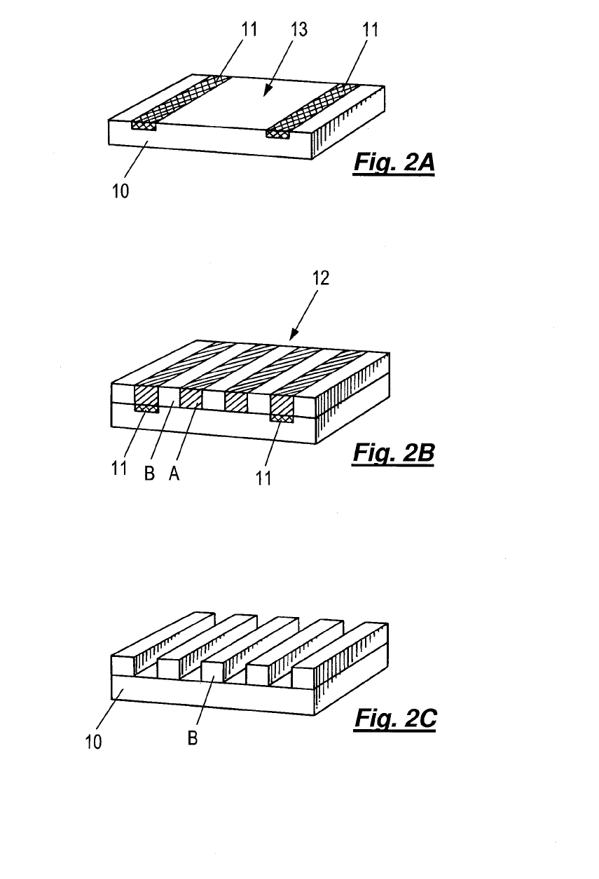

FIG. 2A shows a substrate 10 with a chemical pattern in the form of pinning stripes 11 which have been chemically formed on the surface 13 to provide regions with a higher affinity for the type A blocks of the polymer. In FIG. 2B, a self-assemblable A-B block copolymer with, e.g., hydrophilic A blocks and, e.g., hydrophobic B blocks has been deposited onto the surface 13 of substrate 10 to form a lamellar phase layer 12 with alternating stripes of A and B domains which have phase separated into discrete micro-separated periodic domains during deposition of the block copolymer. This is referred to as chemical pre-patterning. The type A domains have nucleated atop the pinning stripes 11, which are also, e.g., hydrophilic. In FIG. 1C, the type A domains have been removed by selective chemical etching, leaving the type B domains to form a relief pattern on the surface 13 where they may serve as a template for subsequent patterning of surface 13, for instance by further chemical etching. The pitch or wavelength of the self-assembled polymer structure 12 and the spacing of the pinning stripes 11 are arranged so that a number of alternating stripes of domains can fit between the pinning stripes 11 with a type A domain atop each pinning stripe 11.

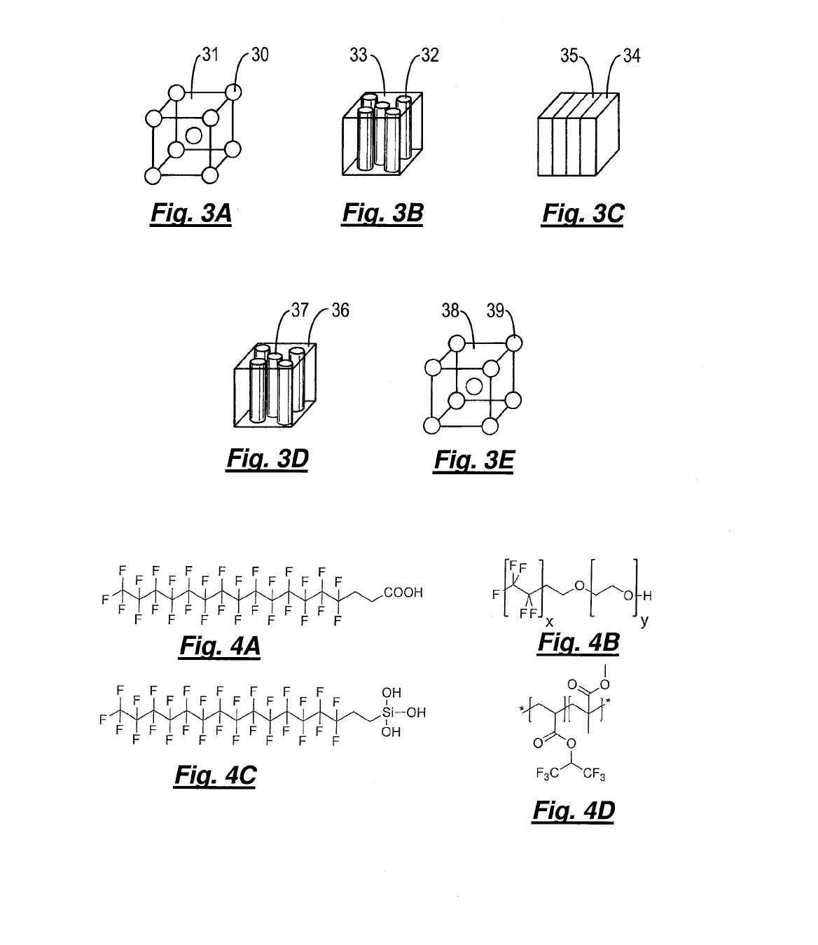

In FIG. 3, FIGS. 3A to 3B show the progression of different phases formed by a self-assembled poly(styrene-b-methylmethacrylate) block copolymer in thin films on a surface. In FIG. 3A, a cubic phase is shown with the discontinuous domains being spheres 30 of PMMA within a continuous domain 31 of PS for a ratio PS:PMMA of 80:20.

As the ratio PS:PMMA reduces to 70:30, a cylindrical phase is formed with the discontinuous domains being cylinders 32 of PMMA and a continuous domain 31 of PS. At 50:50 ratio, a lamellar phase is formed as shown in FIG. 3C with one or more lamellae 34 of PMMA and one or more lamellae 35 of PS. With a ratio of 30:70 PS:PMMA, an inverted cylindrical phase is formed, shown in FIG. 3D, with the discontinuous domains being cylinders 37 of PS and a continuous domain 36 of PS. At a ratio of 20:80, shown in FIG. 3E, an inverted cubic phase is formed with discontinuous domains being spheres 39 of PS within a continuous domain 38 of PMMA. For the cubic and inverted phases, use as a resist layer will typically be achieved by using a thin layer of self-assembled block copolymer so that only a 2-D array is formed on the substrate.

FIGS. 4A to 4D depict molecular structures of embodiments of surfactant suitable for an embodiment of the invention.

FIG. 4A shows a surfactant having a perfluorinated tail and a carboxylic acid polar head group.

FIG. 4B shows a surfactant of the type sold under the trade name Zonyl™ by DuPont, where the tail is a perfluorinated alkyl chain (x being an integer from 6 to 20 say) and the head group is a polyethyleneglycol (PEG) head group with y also an integer (from 1 to 100 say).

FIG. 4C depicts a surfactant having a perfluorinated tail and a trihydroxysilane head group.

FIG. 4D depicts a surfactant having a perfluorinated tail formed from an oligomer of perfluorinated acrylate monomer and a head group which is an oligomer of polymethyl methacrylate.

As has already been explained, an embodiment of the method of the invention is useful in promoting perpendicular orientation of the self-assembled ordered array of block copolymer with respect to the underlying substrate. This enables the formation of a block copolymer-based resist mask which is substantially homogeneous in the direction normal (perpendicular) to the substrate surface, without the need to use an extremely thin block copolymer layer. Other technical benefits may arise from certain features of embodiments of the invention.

An embodiment of the method of the invention reduces the free energy penalty for cylinders or lamellae to form into arrays with perpendicular orientation, and this may also encourage annihilation of local defects due to local disorientation. An embodiment of the invention applies to both graphoepitaxial and chemical epitaxy substrates and is useful for spherical, cylindrical and/or laminar (lamellar) phases. The methods herein are not restricted to use with di-block copolymer, and could easily be applied, for instance, to tri-block copolymer.

As mentioned above, the first surfactant may have a molecular weight substantially less than the molecular weight of the block copolymer. This difference in molecular weight between first surfactant and block copolymer may help ensure that the first surfactant is unlikely to self-assemble alongside the block copolymer, and should also inhibit miscibility of the first surfactant with the block copolymer, encouraging the first surfactant to remain in place at the external surface interface. When deposition of the first surfactant at the surface is achieved by depositing a layer of liquid composition containing block copolymer, solvent and first surfactant onto a surface and then removing the solvent so that the first surfactant migrates to and is deposited at the external surface of the block copolymer layer, it is desirable that the first surfactant is sufficiently immiscible with the block copolymer so that the first surfactant is not present at substantial levels (say 1% by weight or more) within the ordered array of block copolymer.

The hydrophobic tails of the first surfactant molecules may be adapted for mutual crosslinking, wherein following deposition of the first surfactant onto the external surface, the hydrophilic tails are mutually crosslinked. This crosslinking may be useful to reduce volatility of the adsorbed first surfactant in order to prevent or reduce loss of first surfactant from the external surface during an annealing process used to induce self-assembly of the block copolymer into an ordered array. Crosslinking may also be effective to help prevent incorporation of the surfactant into the bulk of the block copolymer layer by diffusion. This may be particularly useful when volatile first surfactant is used, deposited onto the external surface in the vapor phase and subsequently crosslinked.

The hydrophilic head group may be suitable an oligomeric moiety of the same monomer or monomers as a monomer or monomers of the hydrophilic block of the block copolymer. For instance, if the hydrophilic block of the block copolymer is a homopolymer of ethylene oxide monomer, the head group of the first surfactant may be an oligomer of ethylene oxide monomer. This helps to ensure that the head group of the first surfactant is compatible with and adsorbs readily onto the hydrophilic block of the block copolymer at the external surface of the layer.

Although the hydrophilic tail may be miscible with the hydrophobic block of the block copolymer, in an embodiment, the hydrophobic tail group of the first surfactant is adapted to be immiscible with the hydrophobic block of the block copolymer. This is in order to help avoid a local decrease in Flory-Huggins parameter within the layer, as the presence of surfactant may favor comingling of the blocks of the block copolymer. Also, the immiscibility of the hydrophobic tail group of the first surfactant with the hydrophobic block of the block copolymer may assist in reducing risk of the first surfactant adsorbing onto the hydrophilic domain of the block copolymer at the external face of the layer, as this may lead to an arrangement favoring parallel orientation rather than perpendicular orientation, should the adsorption of the first surfactant lead to the hydrophilic head group oriented outwards at the external surface.

For instance, if the hydrophobic tail group of the first surfactant is or has a perfluorinated moiety, or a polydimethylsiloxane (PDMS) moiety, then if the hydrophobic block of the block copolymer is a hydrocarbon such as polystyrene, the perfluorinated or PDMS moiety will help to ensure that the hydrophilic tail of the first surfactant is immiscible with the hydrophobic block. A perfluorinated surfactant, for instance, is particularly useful as a first surfactant for use with the methods herein, with the tail having high affinity for air, while the polar head group provides a free energy benefit for the hydrophilic block of the block copolymer to orient at the interface. In the event that the free energy benefit is such that parallel orientation (with the hydrophilic block at the external surface) would be favored, a partially fluorinated tail may be used instead of a perfluorinated tail with the aim of balancing the presence of both hydrophilic and hydrophobic blocks at the external surface. Another possibility is to tune the amount of first surfactant deposited and adsorbed at the external surface (say with about 50% coverage) to allow both hydrophilic and hydrophobic blocks to be present at the surface.

The hydrophobic tail group and the hydrophilic head group of the first surfactant may linked by a cleavable linking group, the method further comprising cleaving the cleavable linking group after treating the layer to cause self-assembly of the self-assemblable block copolymer and removing the hydrophilic tail group following cleavage.

In an embodiment, in general, the first surfactant adsorbed at the external surface may be in the form of a layer so thin (say a few nanometres in thickness) that it is not necessary to remove the first surfactant in order to use the resulting, ordered array as a resist layer for device lithography. However, in some applications, the presence of a highly hydrophobic moiety, especially if the first surfactant tail is based upon a perfluorinated moiety, may hinder the deposition and adhesion of an additional layer to be applied to the ordered array of block copolymer. This may be important, for instance, during multiple resist layer processing. Hence it may be desirable to be able to remove the hydrophobic first surfactant tail following formation of the ordered array. This may be achieved by means of a cleavable linking group in the first surfactant, linking the hydrophobic head group and the hydrophilic tail. A cyclic and/or acyclic acetal, ketal, and/or ortho-ester are examples of known cleavable linking groups suitable for cleavage by an acid, whereas a linking group cleavable by an alkali include an ester bond. Alternatively or additionally, the presence of an azo bond or a nitrophenyl group may allow for cleavage directly by actinic radiation, such as UV radiation.

The deposition of the first surfactant onto the external surface may also include depositing a second surfactant onto the external surface, the second surfactant having a second head group adapted to adsorb the second surfactant to a hydrophobic block of the block copolymer and a second tail group adapted to be immiscible with both the hydrophilic and hydrophobic blocks of the block copolymer. In particular, the tail group of the first surfactant and the tail group of the second surfactant may be chemically identical. This may be advantageous for helping to ensure that both the hydrophilic and hydrophobic blocks of the block copolymer may be located at the external surface to encourage perpendicular orientation of the ordered array.

The molar ratio between first and second surfactant is desirably equal or close to equal to the molar ratio between the two blocks in the block copolymer. This is advantageous for helping to ensure that both blocks may fully be covered by the most optimal surfactant at the external surface to further stabilize perpendicular orientation of the ordered array.

Thus, in an embodiment, there is described a method of forming a self-assembled block polymer layer, oriented to form an ordered array of alternating domains, arranged to lie side-by-side on a substrate. The method involves providing a layer of the self-assemblable block copolymer on the substrate, typically in a disordered state, and depositing a first surfactant onto the external surface of the layer prior to inducing self-assembly of the layer to form the ordered array of domains. The first surfactant has a hydrophobic tail and a hydrophilic head group and acts to reduce the interfacial energy at the external surface of the block copolymer layer in order to promote formation of assembly of the block copolymer polymer into an ordered array having the alternating domains lying side-by-side on the substrate. In other words, the block copolymer molecules in the regular array are oriented so that adjacent blocks of copolymer molecules are aligned side-by-side in the layer to form adjacent domains alternating with a periodicity along the plane of the layer, avoiding stacking to form alternating domains having a periodicity along an axis normal to the plane of the layer. In embodiment, the first surfactant has a molecular weight substantially lower than that of the block copolymer, and is desirably immiscible with the block copolymer. The first surfactant may be provided with a cleavable linkage between the tail and head groups to facilitate subsequent use of the ordered block copolymer layer as a highly ordered resist layer for device lithography of the substrate. A device lithography method for patterning a surface of a substrate by resist etching, using the self-assembled block polymer as a resist layer, is also disclosed.

The described and illustrated embodiments are to be considered as illustrative and not restrictive in character, it being understood that only preferred embodiments have been shown and/or described and that all changes and modifications that come within the scope of the inventions as defined in the claims are desired to be protected. For instance, rather than the first and second blocks of the block copolymer being of polymethylmethacrylate PMMA and polystyrene PS, other mutually chemically immiscible blocks may be used in the self-assemblable block copolymer to drive the self-assembly process, for instance with PMMA replaced by polyethylene oxide PEO.

An embodiment of the present invention relates to lithography methods. The methods may be used in processes for the manufacture of devices, such as electronic devices and integrated circuits or other applications, such as the manufacture of integrated optical systems, guidance and detection patterns for magnetic domain memories, flat-panel displays, liquid-crystal displays (LCDs), thin film magnetic heads, organic light emitting diodes, etc. An embodiment of the invention is also of use to create regular nanostructures on a surface for use in the fabrication of integrated circuits, bit-patterned media and/or discrete track media for magnetic storage devices (e.g. for hard drives).

In particular, an embodiment of the invention is of use for high resolution lithography, where features patterned onto a substrate have a feature width or critical dimension of about 1 μm or less, typically 100 nm or less or even 10 nm or less.

Lithography may involve applying several patterns onto a substrate, the patterns being stacked on top of one another such that together they form a device such as an integrated circuit. Alignment of each pattern with a previously provided pattern is an important consideration. If patterns are not aligned with each other sufficiently accurately, then this may result in some electrical connections between layers not being made. This, in turn, may cause a device to be non-functional. A lithographic apparatus therefore usually includes an alignment apparatus, which may be used to align each pattern with a previously provided pattern, and/or with alignment marks provided on the substrate.

In this specification, the term “substrate” is meant to include any surface layers forming part of the substrate, or being provided on a substrate, such as other planarization layers or anti-reflection coating layers which may be at, or form, the surface of the substrate.

1. A method of forming an ordered array of self-assemblable block copolymer on a substrate, the method comprising:
providing a substrate having a layer of self-assemblable block copolymer thereon, the block copolymer having a molecule comprising a hydrophilic block and a hydrophobic block, and the layer having an external surface,
depositing a first surfactant onto the external surface of the layer, the first surfactant having a molecule with a hydrophobic tail and a hydrophilic head group, the hydrophilic head group adapted to adsorb the first surfactant to the hydrophilic block of the block copolymer, and
treating the layer to cause self-assembly of the self-assemblable block copolymer to form the ordered array of self-assemblable block copolymer from the layer on the substrate.

2. The method of claim 1, wherein the first surfactant has a molecular weight of 20% or less than the molecular weight of the block copolymer.

3. The method of claim 1, wherein the hydrophilic head group is an oligomeric moiety of the same monomer or monomers as a monomer or monomers of the hydrophilic block of the block copolymer.

4. The method of claim 1, wherein the hydrophobic tail group of the first surfactant is adapted to be immiscible with the hydrophobic block of the block copolymer.

5. The method of claim 4, wherein the hydrophobic tail group of the first surfactant comprises a perfluorinated moiety.

6. The method of claim 4, wherein the hydrophobic tail group of the first surfactant comprises a polydimethylsiloxane moiety.

7. The method of claim 1, wherein the hydrophobic tail group and the hydrophilic head group of the first surfactant are linked by a cleavable linking group, and the method further comprises cleaving the cleavable linking group after the treating of the layer to cause self-assembly of the self-assemblable block copolymer and removing the hydrophilic tail group following cleavage.

8. The method of claim 1, wherein the first surfactant is deposited onto the external surface by adsorption from a liquid composition comprising a solvent and the first surfactant.

9. The method of claim 8, wherein the first surfactant is deposited onto the external surface by Langmuir-Blodgett deposition from the liquid composition.

10. The method of claim 1, wherein the first surfactant is deposited onto the external surface by deposition from a vapor phase.

11. The method of claim 1, wherein the first surfactant is deposited onto the external surface by contact printing.

12. The method of claim 1, comprising providing the layer of self-assemblable block copolymer on the substrate by:
depositing a film of liquid composition comprising the first surfactant, the block copolymer and a solvent onto the substrate, and
removing the solvent by evaporation to form the layer of self-assemblable block copolymer,
wherein the first surfactant is immiscible with the block copolymer and migrates to, and is deposited, on the external surface as the solvent is removed.

13. The method of claim 1, wherein the hydrophobic tails of molecules of the first surfactant are adapted for mutual crosslinking, and wherein following deposition of the first surfactant onto the external surface, the hydrophilic tails are mutually crosslinked.

14. The method of claim 1, wherein the depositing of the first surfactant onto the external surface of the layer includes depositing a second surfactant onto the external surface, the second surfactant having a second head group adapted to adsorb the second surfactant to a hydrophobic block of the block copolymer and a second tail group adapted to be immiscible with both the hydrophilic and hydrophobic blocks of the block copolymer.

15. The method of claim 14, wherein the tail group of the first surfactant and the tail group of the second surfactant are chemically identical.

16. A lithography method for patterning a surface of a substrate by resist etching, wherein the method comprises providing an ordered array of self-assemblable block copolymer on a substrate at the surface by the method of claim 1, wherein the ordered array of self-assemblable block copolymer layer is used as a resist layer.

17. A method for forming a device topography at a surface of a substrate, the method comprising using an ordered array of self-assemblable block copolymer formed on the substrate by the method of claim 1 as a resist layer while etching the substrate to provide the device topography.
